(19) United States
(12) Patent Application Publication
(10) Pub. No.: US 2026/0346202 A1
(43) Pub. Date: Nov. 5, 2026

(54) CATALYTICALLY ACTIVE PARTICULATE FILTER WITH A HIGH DEGREE OF FILTRATION EFFICIENCY AND OXIDATION FUNCTION

(71) Applicant: UMICORE AG & CO. KG, Hanau-Wolfgang (DE)

(72) Inventors: Jan SCHOENHABER, Darmstadt (DE); Carolin BRAUN, Langen (DE); Meike Antonia GOTTHARDT, Frankfurt (DE); Johannes SCHUEHLE, Hanau (DE); Frank ADAM, Linsengericht (DE)

(73) Assignee: UMICORE AG & CO. KG, Hanau-Wolfgang (DE)

(21) Appl. No.: 19/100,069

(22) PCT Filed: Jul. 27, 2023
(86) PCT No.: PCT/EP2023/070796

§ 371 Date: Jan. 30, 2025

(30) Foreign Application Priority Data
Aug. 5, 2022 (DE) 10 2022 002 854.9

(51) Int. Cl. B01D 53/94; B01J 23/44; B01J 35/00; B01J 35/56; F01N 3/28

(52) U.S. Cl. CPC B01D 53/9472; B01J 23/44; B01J 35/19; B01J 35/56; F01N 3/2825; B01D 2255/1021; B01D 2255/1023; B01D 2255/9155; B01D 2258/014; F01N 2370/02

(57) ABSTRACT

The present invention relates to a wall-flow filter as a particulate filter with catalytically active coatings in the channels, which are gas-tightly closed at the opposing closed ends. Initially, a filtration-increasing coating F, a dry powder-gas aerosol with compounds such as Al2O3, SiO2, FeO2, TiO2, ZnO2, ZrO2, zeolites, cordierites or different silicates, is applied to the filter. Then, a catalytically active coating Z with Pt and/or Pd is applied over a sub-region or over the entire length (L) of the filter.

The present invention relates to a wall-flow filter and a corresponding system comprising the wall-flow filter according to the invention. A method for reducing exhaust gas is also a subject of this invention.

The exhaust gas from internal combustion engines in motor vehicles typically contains the harmful gases carbon monoxide (CO) and hydrocarbons (HC), nitrogen oxides (NOx) and possibly sulfur oxides (SOₓ), as well as particles consisting largely of solid carbonaceous particles and possibly adhering organic agglomerates. They are referred to as primary emissions. CO, HC and particles are products of incomplete combustion of the fuel in the combustion chamber of the engine. Nitrogen oxides are formed in the cylinder from nitrogen and oxygen of the intake air when the combustion temperatures exceed 1200 °C. Sulfur oxides result from the combustion of organic sulfur compounds, which are always contained in small quantities in non-synthetic fuels. Compliance with regulatory emission limits applicable to motor vehicles in Europe, China, North America and India in the future requires extensive removal of the mentioned pollutants from the exhaust gas. For removing these emissions, which are harmful to the environment and health, from the exhaust gases of motor vehicles, a variety of catalytic exhaust gas cleaning technologies have been developed, the basic principle of which is usually based on conducting the exhaust gas to be cleaned over a flow-through or a wall-flow honeycomb body with a catalytically active coating applied thereto. The catalyst promotes the chemical reaction of various exhaust gas components to form harmless products, such as carbon dioxide, water and nitrogen. For removing particle emissions, diesel particulate filters (DPF) or gasoline particulate filters (GPF)/Otto particulate filters (OPF) with and without additional catalytically active coating are suitable aggregates.

The flow-through or wall-flow honeycomb bodies described above are also referred to as catalyst carriers, carriers, substrates or substrate monoliths since they carry the catalytically active coating on their surface or in the walls forming this surface. The catalytically active coating is often applied in the form of a suspension to the catalyst carrier in a so-called coating process. Many such processes have been published by car exhaust catalyst manufacturers in the past (EP1064094B1, EP2521618B1, WO10015573A2, EP1136462B1, U.S. Pat. No. 6,478,874B1, U.S. Pat. No. 4,609,563A, WO9947260A1, JP5378659B2, EP2415522A1, JP2014205108A2).

Exhaust gases from internal combustion engines operated with a predominantly (>50% of the operating time) stoichiometric air/fuel mixture, i.e., for example gasoline engines operated with gasoline or natural gas, are cleaned in conventional methods using three-way catalysts (TWC). These catalysts are capable of simultaneously converting the three major gaseous pollutants of the engine, namely, hydrocarbons, carbon monoxide and nitrogen oxides, into harmless components. Stoichiometric means that, on average, the amount of air available to burn the fuel present in the cylinder is exactly the amount of air needed for complete combustion. The combustion air ratio λ (A/F ratio; air/fuel ratio) sets the mass of air m_{L,tats} actually available for combustion in relation to the stoichiometric mass of air m_{L,st}:

$$λ = \frac{{m}_{L , tats}}{{m}_{L , st}}$$

If λ<1 (e.g., 0.9), this means “deficient air” and is referred to as a rich exhaust gas mixture; λ >1 (e.g., 1.1) means “excess air” and the exhaust gas mixture is referred to as lean. The statement λ=1.1 means that 10% more air is present than would be necessary for the stoichiometric reaction. The same applies to exhaust gas from internal combustion engines.

As catalytically active materials, platinum group metals, in particular platinum, palladium and rhodium, which are, for example, present on y aluminum oxide as the carrier material, are generally used in the known three-way catalysts. In addition, three-way catalysts contain oxygen storage materials, for example cerium/zirconium mixed oxides. In the latter, cerium oxide, a rare earth metal oxide, is the basic component for oxygen storage. In addition to zirconium oxide and cerium oxide, these materials may contain additional constituents such as further rare earth metal oxides or alkaline earth metal oxides. Oxygen storage materials are activated by applying catalytically active materials such as platinum group metals and thus also serve as a carrier material for the platinum group metals.

For complying with the regulatory standards, it may be desirable for current and future applications for exhaust gas aftertreatment of internal combustion engines for cost reasons but also for installation space reasons to combine particulate filters with catalytically active functionalities. The use of a particulate filter, whether catalytically coated or not, results in a noticeable increase in exhaust gas backpressure in comparison to a flow-through carrier of the same dimensions and thus to a reduction in engine torque or possibly increased fuel consumption. In order not to further increase the exhaust gas backpressure, the quantities of oxidic carrier materials for the catalytically active elements of the catalyst or oxidic catalyst materials are generally applied to a filter in smaller amounts than to a flow-through carrier. There has already been some effort to provide particulate filters that have good catalytic activity through an active coating while still exhibiting the lowest possible exhaust gas backpressure. With regard to low exhaust gas backpressure, it has been shown to be favorable if the catalytically active coating is not located as a layer on the channel walls of a porous wall-flow filter, but rather the channel walls of the filter are interspersed with the catalytically active material, see, for example, WO2005016497A1, JPH01-151706 and EP1789190B1. For this purpose, the particle size of the catalytic coating is selected such that the particles can penetrate into the pores of the wall-flow filters and be fixed there by calcining. A disadvantage of catalytically active filters with an in-wall coating is that the quantity of catalytically effective substance is limited by the holding capacity of the porous wall.

It has been shown that applying the catalytically active substances to the surfaces of the channel walls of a wall-flow honeycomb body can achieve an increase in the conversion of the pollutants in the exhaust gas. Combinations of both on-wall and in-wall coatings with catalytically active material are also possible, which can further increase catalytic performance without significantly increasing the dynamic pressure, EP3501648 A1.

In addition to catalytic effectiveness, a further functionality of the filter that can be improved by a coating is its filtration efficiency, i.e., the filtering effect itself. WO2011151711A1 describes a method by means of which a dry aerosol is applied to a non-coated or catalytically coated filter carrying the catalytically active material in the channel walls (in-wall coating with washcoat). The aerosol is provided through the distribution of a powdered mineral material and is passed over the inlet side of a wall-flow filter by means of a gas stream. In the process, the individual particles with a particle size of 0.2 μm to 5 μm agglomerate to form a bridged network of particles and are deposited as a layer on the surface of the individual inlet channels extending through the wall-flow filter. The typical loading of a filter with the powder is between 5 g and 50 g per liter of filter volume. It is expressly noted that it is undesirable to use the metal oxide to achieve a coating in the pores of the wall-flow filter.

A further method for increasing the filtration efficiency of catalytically inactive filters is described in WO2012030534A1. In this case, a filtration layer (“discriminating layer”) is generated on the walls of the flow channels of the inlet side by depositing ceramic particles via a particle aerosol. The layers consist of oxides of zirconium, aluminum or silicon, preferably in fiber form from 1 nm to 5 μm in length and have a layer thickness of more than 10 μm, generally 25 μm to 75 μm. After the coating process, the applied powder particles are calcined in a heat process.

A further method, in which a membrane (“trapping layer”) is generated on the surfaces of the inlet channels of filters in order to increase the filtration efficiency of catalytically inactive wall-flow filters, is described in patent specification U.S. Pat. No. 8,277,880B2. The filtration membrane on the surfaces of the inlet channels is realized by suctioning through a gas stream loaded with ceramic particles (e.g., silicon carbide or cordierite). After application of the filter layer, the honeycomb body is burned at temperatures of greater than 1000 °C in order to increase the adhesive strength of the powder layer on the channel walls. EP2502661A2 and EP2502662B1 mention further on-wall coatings through powder application.

A coating within the pores of a wall-flow filter substrate by means of atomization of dry particles is described in U.S. Pat. No. 8,388,721B2. In this case, however, the powder is to penetrate deeply into the pores. 20% to 60% of the surface of the wall is to remain accessible to soot particles, thus open. Depending on the flow rate of the powder-gas mixture, a more or less strong powder gradient can be adjusted between the inlet side and the outlet side. The pores of the channel walls of the filter coated with powder in the pores according to U.S. Pat. No. 8,388,721B2 can subsequently be coated with a catalytically active component. Here, too, the catalytically active material is located in the channel walls of the filter.

The introduction of the powder into the pores, for example by means of an aerosol generator, is described in EP2727640A1. Here, a non-catalytically coated wall-flow filter is coated with a gas stream containing, for example, aluminum oxide particles, in such a way that the complete particles, which have a particle size of 0.1 μm to 5 μm, are deposited as a porous filling in the pores of the wall-flow filter. The particles themselves can realize a further functionality of the filter in addition to the filtering effect. By way of example, these particles are deposited in the pores of the filter in an amount of more than 80 g/L in relation to the filter volume. They fill 10% to 50% of the volume of the filled pores in the channel walls. Both when loaded with soot and without soot, this filter has improved filtration efficiency in comparison to the untreated filter at a lower exhaust gas backpressure of the soot-laden filter.

In WO2018115900A1, wall-flow filters are coated with a possibly dry synthetic ash in such a way that a continuous membrane layer is formed on the walls of the possibly catalytically coated wall-flow filter.

WO 2020/047708 and WO 2020/047503 also describe wall-flow filters in which inorganic secondary particles consisting of aluminum oxide and a silicon-containing binder are deposited on the filter by means of a gas stream, which results in increased durability of the filtration layer.

All prior-art patents listed above are intended to increase the filtration efficiency of a filter by covering the filter with a powder or a membrane. In this way, wall-flow filters can be produced that are capable of almost completely filtering the incoming soot particles. Deposition rates and filtration efficiencies of greater than 99% in the common test cycles can be achieved in this case. The catalytic coating of these filters with a common washcoat consisting of oxide particles and precious metal components, on the other hand, results in a decrease in the original filtration efficiency of the starting filter since the introduction of the coating influences the flow of gas through the filter and the pore structure of the filter. It is usually not relevant in this case whether the catalytic coating is located in the pores of the porous filter wall or on the channel surfaces of the outlet channels.

In the course of the extended particle number measurement range in the Euro 7 regulation to 10 nm, instead of 23 nm as before, high filtration efficiency is indispensable in the future (PN10 measurement). In addition, the new particle number measurement method requires that even very small particles consisting of volatile organic components can be detected, which in turn manifests in a higher measured particle number at the end of the exhaust line. This, in conjunction with a further statutory reduction of the particle number limit for internal combustion engines, results in the need for wall-flow filters in the future that have a very high filtration efficiency and are simultaneously capable of oxidizing volatile organic particles to form CO₂, so that they are no longer detected as particles within the framework of the PN10 measurement required in the future.

The object of the present invention is therefore to provide a correspondingly coated particulate filter, with which, on the one hand, the excellent filtration efficiency of the wall-flow filter already provided with a layer that increases filtration efficiency is maintained and not reduced and, on the other hand, a precious metal component that catalyzes the oxidation of volatile organic particles is applied. Preferably, applying the precious metal component changes neither the filtration performance nor the backpressure of the filter.

These objects and further objects resulting from the prior art in an obvious manner are achieved by a particulate filter according to claims 1 to 14. Claims 15 and 16 relate to an exhaust system. Claims 17 and 18 relate to a method for exhaust gas cleaning by using the particulate filter according to the invention for the exhaust gas aftertreatment of internal combustion engines, in particular predominantly stoichiometrically operated internal combustion engines.

The present invention relates to a wall-flow filter for removing particles from the exhaust gas of internal combustion engines, in particular predominantly stoichiometrically operated internal combustion engines, which comprises a wall-flow filter substrate of length L and different coatings Z and F, wherein the wall-flow filter substrate comprises channels E and A, which extend in parallel between a first and a second end of the wall-flow filter substrate, are separated by porous walls and form surfaces O_{E} and O_{A}, respectively, and wherein the channels E are closed at the second end and the channels A are closed at the first end, and wherein the coating F is located in the porous walls and/or on the surfaces O_{E} and/or on the surfaces O_{A} and comprises a filtration-increasing layer, and the coating Z is located in the porous walls and/or on the surfaces O_{E} and/or O_{A} and/or on the end faces of the channels E and/or A and/or on the constituents of the coating F and contains platinum and/or palladium, and is characterized in that the coating Z extends over at least a sub-region of 3 mm to 100% of the length L of the filter.

In the intended use of the wall-flow filter according to the invention for the cleaning of exhaust gas from internal combustion engines, the exhaust gas flows into the filter at one end and exits it again at the other end after passing through the porous walls. For example, if the exhaust gas enters the filter at the first end, the channels E denote the input channels or inflow-side channels. After passing through the porous walls, the exhaust gas then exits the filter at the second end so that the channels A denote the output channels or outflow-side channels. L represents the average coatable length of the filter. Due to the plugs at the channel ends, the entire length of the filter does not have to be coated. L represents the sum of the lengths actually available for the coating in the coated channels, averaged over the number of coated channels.

All ceramic wall-flow filter substrates known from the prior art and common in the field of car exhaust gas catalysis can be used as wall-flow substrate. Porous wall-flow filter substrates made of cordierite, silicon carbide or aluminum titanate are preferably used. These wall-flow filter substrates have channels E and channels A, which function as described above as input channels, which may also be referred to as inflow-side channels, and as output channels, which may also be referred to as outflow-side channels. The outflow-side ends of the inflow-side channels and the inflow-side ends of the outflow-side channels are closed with generally gas-tight “plugs” in a manner offset from one another. In this case, the exhaust gas to be cleaned, which flows through the filter substrate, is forced to pass through the porous wall between the inflow-side and the outflow-side channel, which causes a particulate filtering effect. The porosity, pore/radius distribution and thickness of the wall allow the filtration property to be designed for particles. According to the invention, the porosity of the uncoated wall-flow filter substrates is generally more than 40%, for example from 40% to 75%, particularly from 50% to 70% [measured according to DIN 66133, latest version on the filing date]. The average pore size d₅₀ of the uncoated wall-flow filter substrates is at least 4 μm, for example from 4 μm to 34 μm, preferably more than 6 μm, in particular more preferably from 6 μm to 25 μm, or most preferably from 7 μm to 17 μm [measured according to DIN 66134, latest version on the filing date], wherein the d50 value of the pore size distribution of the wall-flow filter substrate is understood to mean that 50% of the total pore volume that can be determined by mercury porosimetry is formed by pores whose diameter is less than or equal to the value specified as d50. In the case of the wall-flow filters according to the invention, the wall-flow filter substrates provided with the coating Z preferably have no change in the pore size distribution in comparison to that of the original filter, which is only provided with coating F.

### Coating F:

The term “filtration-increasing” is understood according to the invention to mean that, through the coating F, the wall-flow filter obtains the ability to retain particles from the exhaust gas stream better than the original filter, without the exhaust gas backpressure increasing exorbitantly in comparison to the starting substrate. Preferably, this means that the filtration efficiency of the filter increases by more than 2 percentage points, more preferably by more than 5 percentage points, and most particularly preferably by more than 10 percentage points in comparison to the starting substrate, without the exhaust gas backpressure increasing by more than 60%, preferably less than 50%, and most preferably less than 40%, in comparison to the starting substrate.

The increase in the filtration efficiency of the filter with coating F in comparison to the raw filter is calculated according to the following formula:

FE increase through coating F>/=(100%−FE_{before F})×increase factor

Wherein the increase factor in the case according to the invention is in the range of 0.2-0.99, preferably in the range of 0.35-0.95, and particularly preferably in the range of 0.5-0.85. This is in particular advantageous for filter substrates that already have high filtration performance in the starting substrate.

The increase in the exhaust gas backpressure can be calculated according to the following formula:

Backpressure increase through coating F=((backpressure with F/backpressure without F)−1)×100

Coating F advantageously does not comprise any precious metal. It is thus preferably not catalytically active in the sense of the present invention. In particular, it is substantially unable to oxidize carbonaceous particles such as soot or volatile hydrocarbon particles or to oxidize the exhaust gas components CO and HC or to reduce NOₓ. The coating F thus preferably consists of ceramic or oxidic constituents and does not contain any further catalytic components.

Particularly suitable constituents of the coating F contain aluminum oxide, zirconium dioxide, cerium oxide, yttrium oxide, mullite, tin oxide, silicon nitride, zeolite, titanium dioxide, silicon dioxide, aluminum titanate, silicon carbide, cordierites, nesosilicates, phyllosilicates, technical silicates, chain silicates, group silicates, or mixtures thereof.

On-wall F:

The membrane layer preferably has a continuous structure on the surface of the wall of the filter. As such, it preferably lies on the filter wall OF. It may happen that a small portion of the constituents of the membrane layer also penetrates into the pores of the filter. However, in a further preferred embodiment, the filtration-increasing coating F is located substantially on the surfaces OF. This means that the constituents of the coating F are present in the pores of the wall of the filter at less than 20% of the total mass of the coating, preferably less than 10%, and most preferably less than 5%. The quantity of coating components in the wall can be determined as described in WO2019197177A1.

The coating F preferably forms a continuous membrane layer on the surfaces OF. The membrane layer is in particular defined as a continuous, porous layer with a porosity in the range of 30-90%, preferably 40-80% (measured according to DIN 66133, latest version on the filing date). The average pore size d50 of the membrane layer F is at least 50 nm, for example 50 nm to 5 μm, preferably more than 100 nm to 4 μm, in particular more preferably 200 nm to 2.5 μm, wherein the d50 value of the pore size distribution is understood to mean that 50% of the total pore volume that can be determined by mercury porosimetry is formed by pores whose diameter is less than or equal to the value specified as d50.

Accordingly, coating F preferably has a certain thickness over the wall surface, preferably O_{E}. The coating F preferably has a layer thickness of 1 to 150 μm, preferably 2 to 50 μm. The wall-flow filter is characterized in that the ratio of the wall thickness of the wall-flow filter substrate to the thickness of the membrane layer of the coating F is preferably 0.8 to 400, preferably 1 to 300, and particularly preferably 1.25 to 250. In addition, it may happen that the coating F accumulates on the plug area at the channel end when coating in the axial direction. In a preferred embodiment, the thickness of the coating F here is preferably 0.1 to 10 mm, in particular 0.25 to 5 mm.

In the embodiment discussed here, the coating F is thus preferably located on the porous walls of the wall-flow filter substrate. The particle size of the ceramic membrane is adapted to the pore size of the wall-flow filter substrate. The particles of the coating F thus, in particular, have a defined particle size distribution. The coating F preferably has a monomodal or a multimodal or broad q3 particle size distribution. For the definition of the particle size distribution or grain size distribution of the coating F, a distinction is made depending on the method by means of which the quantity of the particles is determined, inter alia between number-related (q0) and volume-related (q3) particle size distributions (M. Stieß, Mechanische Verfahrenstechnik—Partikeltechnologie 1 [Mechanical Process Technology—Particle Technology 1], Springer, 3rd edition 2009, page 29).

If coating F is located on the porous walls of the wall-flow filter substrate, the d50 value of the particle size distribution of the membrane particles (q3; DIN 66143, latest version on the filing date) is advantageously greater than or equal to the d₅₀ value of the pore size distribution of the wall-flow filter substrate (measured according to DIN 66133, latest version on the filing date). Furthermore, the d90 value of the particle size distribution of the coating F is preferably greater than or equal to the d95 value of the pore size distribution of the wall-flow substrate. Alternatively, the d90 value of the particle size distribution of the coating F is preferably less than the d95 value of the pore size distribution of the wall-flow substrate.

If the coating F penetrates into the porous filter wall, the penetration depth is limited. In particular, the penetration depth of the membrane coating F into the filter wall is a maximum of 50% of the wall thickness, preferably a maximum of 40%, and most particularly preferably a maximum of 25%. If the coating F is in part located in the porous walls of the wall-flow filter substrate, between 1 to 50% of the total mass of the coating F is preferably located in the porous walls of the wall-flow filter substrate, preferably 1.5 to 40%, and most particularly preferably 2 to 25%. This evaluation takes place analogously to WO2019197177A1. For example, the coating F is a ceramic membrane, preferably a silicon carbide membrane.

### In-wall F:

In an alternative embodiment, the coating F preferably does not form a continuous coating on the surfaces of the filter, preferably the surface O_{E} (no membrane). In this case, the filtration-increasing coating is in particular defined as a non-continuous layer that selectively forms over the pores of the wall-flow substrate. Within these regions, coating F has a porosity in the range of 30-90%, preferably 40-80%, determined analogously to WO2019197177A1). The average pore size d50 of the coating F is at least 50 nm, for example 50 nm to 5 μm, preferably more than 100 nm to 4 μm, in particular more preferably 200 nm to 2.5 μm, wherein the d50 value of the pore size distribution is understood to mean that 50% of the total pore volume that can be determined by mercury porosimetry is formed by pores whose diameter is less than or equal to the value specified as d50. The values are determined as specified above.

In the embodiment discussed here, the coating F is located, in whole or in part, in the porous walls of the wall-flow filter substrate. The coating F is preferably present in the porous walls of the wall-flow filter substrate at a proportion of 50-100% of the total mass of the coating F, preferably 60-90%, and most particularly preferably 70-80%. The evaluation takes place analogously to WO2019197177A1.

The particle size of the coating F is adapted to the pore size of the wall-flow filter substrate. The particles of the coating F thus, in particular, have a defined particle size distribution. The coating F preferably has a monomodal or a multimodal or broad q3 particle size distribution. If the coating F is located, in whole or in part, in the porous walls of the wall-flow filter substrate, the d₅₀ value of the particle size distribution of the oxides of the membrane particles (q3; DIN 66143, latest version on the filing date) is preferably less than the d₅₀ value of the pore size distribution of the wall-flow filter substrate (measured according to DIN 66133, latest version on the filing date). It is furthermore preferred that the d90 value of the particle size distribution of the oxides is in particular less than the d95 value of the pore size distribution of the wall-flow substrate. In this case, the filtration-increasing coating F is preferably predominantly composed of aluminum oxide.

The coating F, whether continuous or not, can be produced according to the person skilled in the art. The production of the coating F is described in detail in EP2776144A1, WO2020/047506A1, WO2020/047708A1, for example. The coating F may alternatively also be applied to the surfaces O_{E} by a wet chemical coating step. For example, the membrane coating F is first coated onto the surfaces O_{E} and then, after calcining, the coating Z is applied (EP1789190B1 or U.S. Pat. No. 11,161,098BB).

In a further embodiment, the wall-flow filter is characterized in that coating F has an increasing concentration gradient (first derivative of the concentration curve) in the longitudinal direction of the filter from its first to its second end. According to the invention, “increasing gradient” is understood to mean that the gradient of the powder concentration in the filter increases in the axial direction, from the inlet side to the outlet side, possibly from negative values to more positive values. In a preferred embodiment, there is more powder near the output plugs of the inlet channel and significantly less powder at the input of the filter. For describing the gradient, the filter may be divided into three equally long consecutive regions along its longitudinal axis. In a preferred form, the filter is covered with powder in a region near the inlet side and in a region in the center of the filter on less than 40% of the wall surface of the input channel in each case, while more than 40% of the wall surface of the input channel is covered with powder in a region near the outlet side, wherein, in a particularly preferred form, in a region near the inlet side between 5% and 35%, in a region in the center of the filter between 8% and 38%, and in a region near the outlet side between 40% and 60% of the wall surface of the input channel is covered with powder and, in a most particularly preferred form, in a region near the inlet side between 5% and 25%, in a region in the center of the filter between 8% and 30%, and in a region near the outlet side between 45% and 60% of the wall surface of the input channel is covered with powder. The degree of coverage of the wall surface was determined from light microscopy images by means of image analysis. Corresponding images of the inlet channel and the outlet channel were created. In this type of analysis, the average color of the wall surface of the outlet channel that is not covered with powder is determined as a reference. This reference is subtracted from the corresponding image of the regions covered with powder in the inlet channel, wherein the color difference was determined according to CIE76 of the International Commission on Illumination with a minimum distinguishable color difference of 2.33 (https://en.wikipedia.org/wiki/Color_difference #CIE76).

The gradient produced by the powder coating is advantageous for a further increased filtration efficiency. In one embodiment, the concentration gradient is designed, for example by varying the powder deposition rate, such that more powder is deposited on the inlet side in the filter than in the center of the filter and on the outlet side. In a more preferred embodiment, the concentration gradient may be designed such that more powder is deposited on the inlet side of the filter than in the center of the filter, and on the outlet side (at the other end of the filter) more than on the inlet side. Simulation results have provided the following image in this regard (Table 1).

TABLE 1
Powder distribution over the filter at
different space velocities of the gas:

| | Mass flow | | |
|---|---|---|---|
| Channel length | 10 m/s | 20 m/s | 40 m/s |
| 1/3 | 26% | 18% | 11% |
| 2/3 | 16% | 12% | 9% |
| 3/3 | 58% | 69% | 80% |

Simulations of the gas flow in a wall-flow filter have shown that the last third of the substrate is mainly (more than 50%) responsible for the filtration property of the total filter. By increasing the application of coating F in the last third of the filter, the dynamic pressure there is increased more, which is due to the lower permeability, and the flow shifts more into the first two thirds of the filter. The filter should therefore have a more strongly increasing gradient of the coating F from the first end to the second end in order to increase its filtration effect. This applies mutatis mutandis to adjusting an advantageous exhaust gas backpressure. Accordingly, a less strongly increasing gradient of the concentration of coating F should possibly be selected here.

Preferably, the wall-flow filter comprises a coating F, which has a mass of 1 to 50 g/L in relation to the volume of the wall-flow filter substrate. Further preferably, the mass of the coating F is 5 to 40 g/L, and most preferably 10 to 30 g/L, in relation to the volume of the wall-flow filter substrate.

Preferably, the components of coating F are fixed to the ceramic wall-flow substrate. This can preferably be achieved by using a suitable binder. Such binders are sufficiently known to the person skilled in the art and are disclosed, for example, in WO2020047506A1. The thermal fixation of the coating F is also preferred. Known methods in this regard are also known to the person skilled in the art from WO2012030533A1 and EP21164198.0, for example.

As an alternative to the powder process just discussed, the coating F may also be applied by wet technology, like a normal washcoat. In this case, it can extend over the entire length L of the wall-flow filter substrate or only over a portion thereof. For example, coating F extends over 0 to 100%, 25% to 80%, or 40% to 60% of the length L of the filter substrate. An extension over 80%-100% of the length L, in particular over 90%-100%, is preferred. In one embodiment of the wall-flow filter according to the invention, the coating F extends over the entire length L of the channels E and abuts the plugs at the channel end.

### Coating Z:

The coating Z is an oxidation-catalytically effective coating. HC and CO as well as soot particles and volatile hydrocarbon particles in the exhaust line are to be oxidized by means of this coating. The person skilled in the art is familiar with what such coatings look like (e.g., U.S. Pat. No. 11,161,098BB). In the present case, the coating Z is characterized in that it has few to no ceramic or oxidic portions. The coating therefore preferably has a mass of the precious metals in the coating Z of 0.1-20 grams per liter of filter volume. Preferred in this context are 1-15 g/L filter volume, particularly preferably 2-10 g/L filter volume. If the coating Z extends only over a sub-region of the filter of length L, higher masses of 5-30 g/L, preferably 5-25 g/L, may occur in this region.

In order to achieve better dispersion and better distribution, coating Z may additionally contain a small quantity of oxidic carrier materials. Advantageously, 5-40 grams per liter of filter substrate volume of ceramic or oxidic carrier materials may be present in coating Z, preferably between 7-25 g/L, and particularly preferably between 10-15 g/L. Common carrier materials in this case are aluminum oxide, boehmite, aluminum sol, or other materials known to the person skilled in the art and already disclosed in EP3505246A1. If present, the ceramic or oxidic components are preferably selected from the group consisting of aluminum oxide or boehmite. The coating Z preferably contains no zeolites and no molecular sieve. If the coating Z extends only over a sub-region of the filter of length L, higher masses of 10-85 g/L, preferably 20-60 g/L, may occur in this region.

In a preferred embodiment, coating Z extends over at least one axial sub-region of the length L of the filter. In a preferred embodiment, the minimum length of the coating Z is at least 3 mm, preferably at least 5 mm, and most preferably at least 10 mm, calculated from the end of the filter. In a further preferred embodiment, the maximum length of the coating Z is 5-100% preferably 10-100%, and most preferably 20-100%, in relation to the length L of the filter. In a further preferred embodiment, coating Z extends over the entire length L of the filter.

Platinum and/or palladium preferably come into consideration as precious metals in the coating Z. The mass ratio of platinum to palladium is preferably 0.05-20, more preferably 0.1-10, and most preferably 1.5-5. Platinum and/or rhodium furthermore preferably come into consideration as precious metals in the coating Z. The mass ratio of platinum to rhodium is preferably 0.05-20, more preferably 0.1-10, and most preferably 1.5-5. Platinum and/or rhodium and/or palladium furthermore preferably come into consideration as precious metals in the coating Z. The mass ratio of platinum to palladium to rhodium is preferably 1-10:1-10:1-2, more preferably 1-10:1-7:1-1.5. Coating Z particularly preferably contains the precious metals platinum and/or palladium, wherein rhodium is advantageously also present only by way of exception as a further precious metal. Particularly preferably, coating Z contains platinum and palladium and no rhodium. In a further embodiment, coating Z contains the precious metals platinum and/or rhodium, wherein palladium is also preferably present only by way of exception as a further precious metal. Particularly preferably, coating Z contains palladium and rhodium and no platinum. In a further embodiment, coating Z contains the precious metals platinum, palladium, and/or rhodium. It is also particularly advantageous in this embodiment if the mass ratio of platinum to palladium is 0.05-20, preferably 0.07-15. The precious metals of the coating Z are preferably not fixed on carrier materials (ceramic or oxidic portions of the coating Z). However, they may deposit on the oxides and constituents of the coating F during the coating process.

The production of the coating medium of the coating Z is known to the person skilled in the art (e.g., U.S. Pat. No. 11,161,098 BB). The coating Z can be applied to the wall-flow filter according to the methods known to the person skilled in the art (e.g., U.S. Pat. No. 11,161,098 BB). In the simplest case, the precious metal(s) are dissolved in water and are applied to the wall-flow filter in this form. Due to the few to no oxidic or ceramic components in the coating Z, the coating has a very low viscosity. The viscosity of the coating medium is preferably less than 0.1 Pas*s, more preferably less than 0.05 Pass, and most preferably less than 30 Pas*s, in each case measured at a shear rate of 100 1/s (revolutions per second) (measured analogously to WO2020109778A1). The viscosity can be adjusted with common thickeners, such as methylcellulose.

In one embodiment according to the invention, coating Z is located in the porous walls and/or on the surfaces O_{E} and/or O_{A} and/or on the end faces of the channels E and/or A and/or on the constituents of the coating F. Preferably, the end faces of the channels O_{E} and/or O_{A} are also provided with the coating Z. In this embodiment, the plugs of the ends E and/or A of the filter at the corresponding ends are coated on the outside of the filter with the coating Z. Coating with Z into the pores of the porous filter wall is also particularly preferred. In a further advantageous embodiment, the coating Z is located exclusively in the pores of the filter substrate. The coating Z may additionally also be deposited on the particles of coating F. Furthermore, coating Z may also be located on the surfaces O_{A}.

The coating Z is a catalytically active coating, in particular due to the constituents platinum and/or palladium and/or rhodium. The term “catalytically active” in the context of the present invention is understood to mean the capability to oxidize carbonaceous particles such as soot or volatile hydrocarbon particles or to oxidize the exhaust gas components CO and HC or to reduce NOₓ. The coating Z is particularly catalytically active at operating temperatures of 200 to 1100 °C. In particular, the term “catalytically active” is understood to mean that, at an exhaust temperature of 500 °C, a lambda value of 1.05, and an exhaust gas mass flow of 70 kg/h, a filter comprising the coatings F and Z can oxidize 10% more soot and/or hydrocarbons in the same time unit than a filter containing only the coating F, preferably 15% more, and most particularly preferably 20% more.

Preferably, coating Z has no appreciable layer thickness and does not rise above the surfaces O_{A} and/or O_{E}. Preferably, the layer thickness of coating Z is less than 5 μm, particularly preferably less than 3 μm, and most particularly preferably less than 1 μm.

The wall-flow filter according to the invention can be produced in that the coatings Z and F are applied to a wall-flow filter substrate. In a preferred embodiment of the wall-flow filter according to the invention, first coating F and then coating Z is applied to the filter substrate. This has the advantage that coating Z is not only deposited on the surfaces O_{E}, O_{A} and in the porous filter wall but can also be additionally deposited on the particles of the coating F.

The application of the coating Z in the case according to the invention is associated with only a very small increase in the exhaust gas backpressure. In comparison to the filter comprising only the coating F, the backpressure is increased by only 15%, preferably by only 10%, and particularly preferably by only 5%, by applying the coating Z, wherein the increase in the exhaust gas backpressure can be calculated according to the following formula:

Backpressure increase through Z=((backpressure with F and Z/backpressure with F without Z)−1)×100

The application of the coating Z in the case according to the invention is associated with only a very small change in the filtration efficiency of the filter. In comparison to the filter comprising only the coating F, the filtration efficiency changes by only 3 percentage points, preferably by only 2 percentage points, and particularly preferably by only 1 percentage point, by applying the coating Z. In the sense of the invention, the term “change” may be understood to mean both an increase and a decrease by the specified range.

The calculation of the filtration efficiency increase is calculated according to the following formula.

Filtration efficiency increase through Z=((filtration efficiency with F and Z/filtration efficiency with F without Z)−1)×100

If the filtration efficiency decreases slightly by introducing Z, the decrease is calculated according to the following formula.

Filtration efficiency decrease through Z=(1−(filtration efficiency with F and Z/filtration efficiency with F without Z))×100

A subject of the present invention is also a system for cleaning exhaust gases from internal combustion engines, in particular from predominantly stoichiometrically operated combustion engines, which system comprises a wall-flow filter according to the invention. Further preferred is a system for cleaning exhaust gases which is characterized in that the wall-flow filter according to the invention is arranged as a separate unit in the exhaust line after a three-way catalyst close to the engine in the direction of the exhaust gas. In particular, it is advantageous if a three-way catalyst is located in a position close to the engine directly on the inflow side of the wall-flow filter according to the invention. It is also advantageous if a three-way catalyst is located on the outflow side of the wall-flow filter according to the invention. It is also advantageous if a three-way catalyst is located on the inflow side and on the outflow side of the wall-flow filter according to the invention. Further preferred is in particular a system for cleaning exhaust gases which is characterized in that, after the wall-flow filter according to the invention in the direction of the exhaust gas, there is at least one further catalyst selected from the group of three-way catalyst, oxidation catalyst, NOₓ storage catalyst, hydrocarbon trap, SCR catalyst, ammonia slip catalyst. The preferred embodiments described for the wall-flow filter according to the invention also apply mutatis mutandis to the system mentioned here.

The present invention alternatively furthermore relates to an exhaust gas cleaning system comprising a filter according to the invention and at least one further catalyst. In one embodiment of this system, at least one further catalyst is arranged upstream of the filter according to the invention. Preferably, this catalyst is a three-way catalyst or an oxidation catalyst or a NOₓ storage catalyst. In a further embodiment of this system, at least one further catalyst is arranged downstream of the filter according to the invention. Preferably, this catalyst is a three-way catalyst or an SCR catalyst or a NOₓ storage catalyst or an ammonia slip catalyst. In a further embodiment of this system, at least one further catalyst is arranged upstream of the filter according to the invention and at least one further catalyst is arranged downstream of the filter according to the invention. Preferably, the upstream catalyst is a three-way catalyst or an oxidation catalyst or a NOₓ storage catalyst, and the downstream catalyst is a three-way catalyst or an SCR catalyst or a NOₓ storage catalyst or an ammonia slip catalyst. The preferred embodiments described for the wall-flow filter according to the invention also apply mutatis mutandis to the exhaust gas cleaning system mentioned here.

A subject of the present invention is also a method for exhaust gas cleaning of an internal combustion engine, wherein the exhaust gases of the engine are conducted over a wall-flow filter according to the invention or a system comprising this wall-flow filter. Preferably, the internal combustion engine is one that is predominantly operated stoichiometrically. The preferred and alternative embodiments of the wall-flow filter according to the invention and of the system also apply mutatis mutandis here.

The term “close to the engine” in the sense of the invention refers to an area in the exhaust line that is in a position close to the engine, i.e., approx. 10-80 cm, preferably 20-60 cm, from the engine exit.

Accordingly, the term “coating” is understood to mean applying catalytically active materials to a wall-flow filter substrate. The coating Z assumes the actual catalytic function. In the present case, coating takes place by applying a correspondingly, preferably aqueous suspension of the catalytically active components into or onto the wall of the wall-flow filter substrate, for example according to EP1789190B1 or U.S. Pat. No. 11,161,098BB. After applying the suspension, the wall-flow filter substrate is in each case dried and, where appropriate, calcined at an increased temperature. The most suitable loading quantity of a filter coated in the wall depends on its cell density, wall thickness and the porosity.

The catalytically coated wall-flow filters according to the invention differ from those that are formed in the exhaust line of a vehicle by ash deposition during operation. According to the invention, the catalytically active wall-flow filter substrates are specifically provided with a coating or, where appropriate, membrane coating F. This has the result that the balance between filtration efficiency and exhaust gas backpressure can be adjusted specifically from the start. The present invention therefore does not include wall-flow filters in which undefined ash depositions have taken place from the combustion of fuel, for example in the cylinder, during driving operation or by means of a burner.

The wall-flow filter according to the invention shows excellent filtration efficiency with no or only a very small increase in the exhaust gas backpressure in comparison to a wall-flow filter containing only the coating F but not coating Z. Preferably, the wall-flow filter according to the invention shows an unchanged soot particle deposition (filtering effect) in comparison to the starting filter, which comprises only the coating F. The low total backpressure is likely due to the fact that the presence of coating F does not greatly reduce the cross-section of the channels on the input side. It is assumed that coating F forms a porous structure, which has a positive effect on the dynamic pressure. Through the coating F, a filter according to the invention also has a lower dynamic pressure after soot loading than an analogous filter without coating F, since this coating largely prevents the soot from penetrating into the porous filter wall. Coating Z gives the wall-flow filter according to the invention an excellent catalytic ability to oxidize soot particles or hydrocarbon particles by being able to lower their ignition temperature and thus facilitate their oxidation.

The filter according to the invention is usually used primarily in internal combustion engines, in particular in internal combustion engines with direct injection or intake manifold injection. Preferably, these engines are predominantly stoichiometrically operated gasoline or natural-gas engines. Preferably, these engines are turbocharged engines. The requirements for gasoline particulate filters (GPF) differ significantly from the requirements for diesel particulate filters (DPF). Diesel engines without DPF may have up to ten times higher particle emissions, in relation to the particulate mass, than gasoline engines without GPF (Maricq et al., SAE 1999-01-01530). In addition, in gasoline engines, there are significantly fewer primary particles and the secondary particles (agglomerates) are significantly smaller than in diesel engines. The emissions in gasoline engines are in the range of particle sizes of less than 200 nm (Hall et al., SAE 1999-01-3530) to 400 nm (Mathis et al., Atmospheric Environment 38, 4347) with the maximum in the range of about 60 nm to 80 nm. The filtration of the nanoparticles in the GPF must therefore take place mainly via diffusion separation. For particles smaller than 300 nm, as the size decreases, the separation by diffusion (Brownian molecular movement) and electrostatic forces become increasingly important (Hinds, W.: Aerosol technology: Properties and behavior and measurement of airborne particles. Wiley, 2nd edition 1999). Nevertheless, the wall-flow filter according to the invention may also be used in the diesel sector.

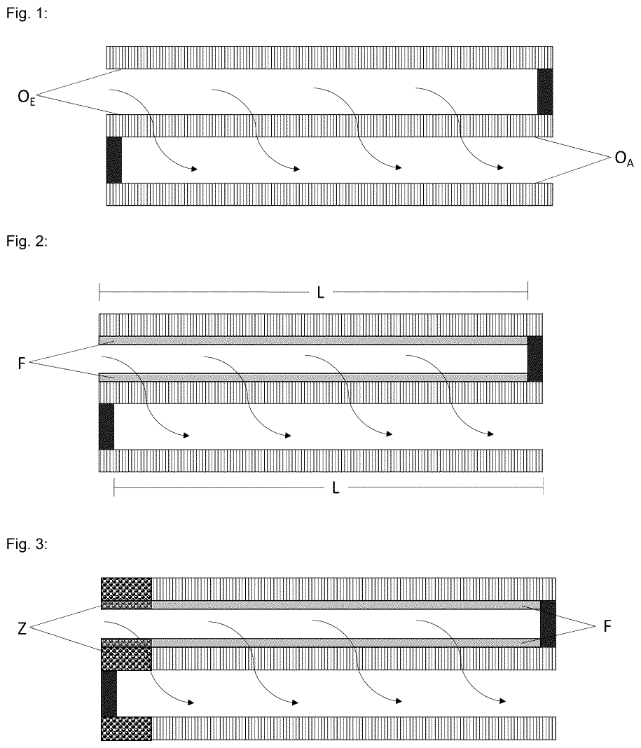

The coatings Z, F may be arranged on the wall-flow filter substrate in various ways. FIGS. 1 to 10 explain this by way of example, wherein FIGS. 2 to 10 relate to wall-flow filters according to the invention which comprise only the coatings Z and F.

FIG. 1 relates to a wall-flow filter substrate with the surfaces O_{E} and O_{A}.

FIG. 2 relates to a wall-flow filter comprising a coating F on the surfaces O_{E}.

FIG. 3 relates to a wall-flow filter according to the invention which comprises a coating F on the surfaces O_{E} and a short zone of coating Z in the input region of the filter.

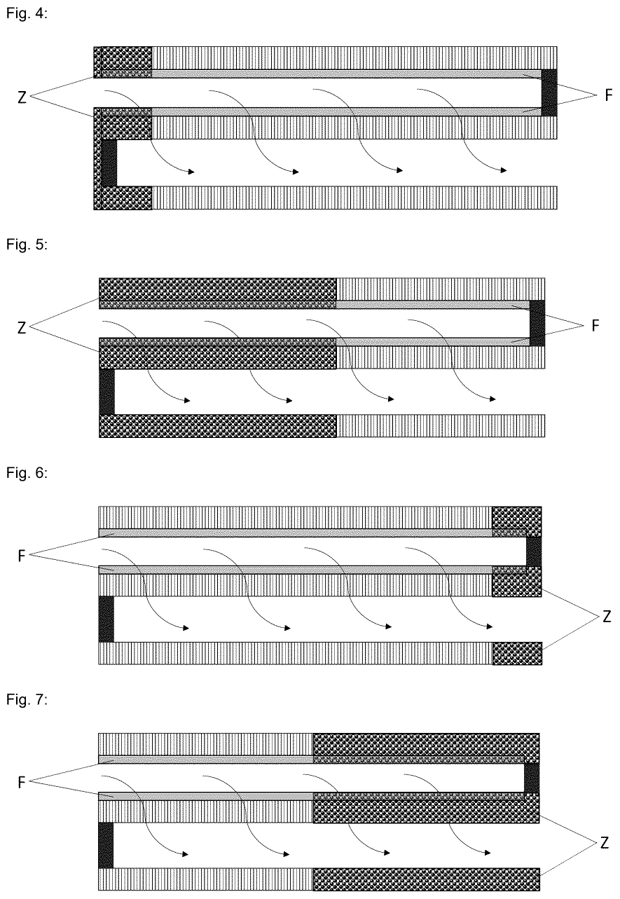

FIG. 4 relates to a wall-flow filter according to the invention which comprises a coating F on the surfaces O_{E} and a short zone of coating Z in the input region of the filter, wherein coating F is also located on the end faces of the plugs.

FIG. 5 relates to a wall-flow filter according to the invention which comprises a coating F on the surfaces O_{E} and a longer zone of coating Z in the input region of the filter.

FIG. 6 relates to a wall-flow filter according to the invention which comprises a coating F on the surfaces O_{E} and a short zone of coating Z in the outlet region of the filter.

FIG. 7 relates to a wall-flow filter according to the invention which comprises a coating F on the surfaces O_{E} and a longer zone of coating Z in the outlet region of the filter.

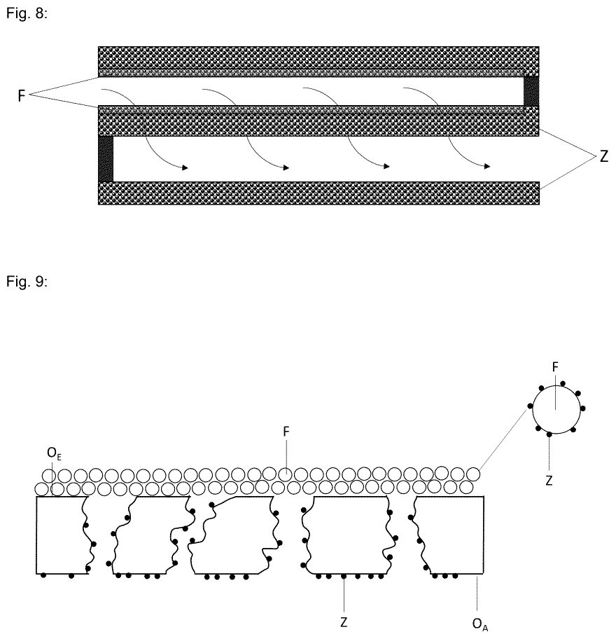

FIG. 8 relates to a wall-flow filter according to the invention which comprises a coating F on the surfaces O_{E} and a coating Z, wherein coating Z extends over the entire filter.

FIG. 9 relates to a wall-flow filter according to the invention and schematically shows that coating Z can be located on the surfaces O_{A} and/or in the pores of the filter substrate and/or on the particles of the coating F.

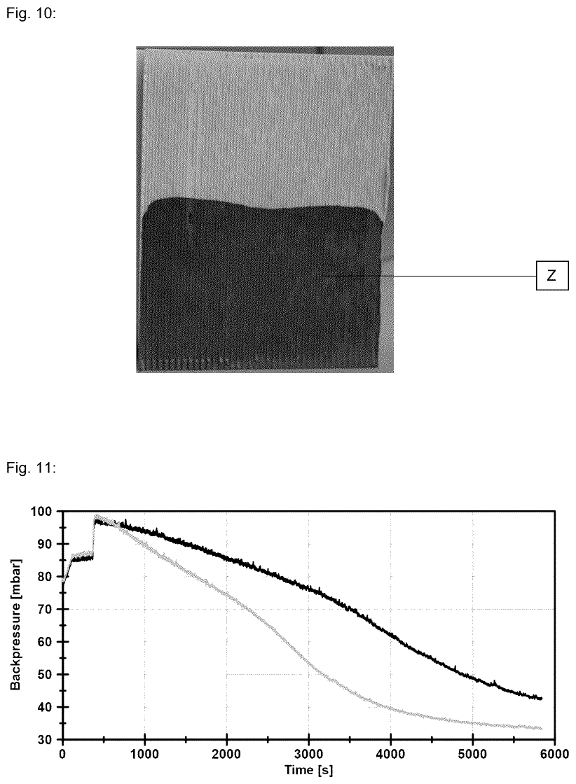

FIG. 10 relates to a wall-flow filter according to the invention and schematically shows an image on which it can be seen that the coating Z extends over approx. 50% of the filter length.

FIG. 11 shows a comparison between a filter without coating Z (black) and a filter according to the invention with coating Z (gray) in the particle oxidation test.

FIGS. 2 to 10 show the different coating arrangements, described in more detail above, of wall-flow filters according to the invention. The reference signs used therein are:
(E) the input channel/inflow-side channel of the wall-flow filter
(A) the outlet channel/outflow-side channel of the wall-flow filter
(O_{E}) the surfaces formed by the input channels (E)
(O_{A}) the surfaces formed by the output channels (A)
(L) the length of the filter wall
(Z) the coating Z
(F) the coating F

The invention is explained below with reference to examples.

### Example 1 According to the Invention

A ceramic filter substrate was provided by means of an aerosol process (EP3774036A1) with approx. 14 g/L of a filtration coating F consisting of a mineral phyllosilicate, and the coating F was subsequently thermally fixed at 900 °C. The filter was then coated with a precious metal solution over a length of 50% of the entire filter length and subsequently dried and calcined. The precious metal concentration, calculated on the basis of the total filter volume, was 3.355 g/L. The precious metal concentration in the zone of the coating Z was accordingly 6.708 g/L.

The filter thus obtained was then investigated on the engine test bench in terms of the backpressure and the particle oxidation capability against a comparison filter that does not contain a coating Z.

First, the pressure loss of the filter before and after the coating Z was measured on a cold gas test bench at an airflow of 600 m³/h. Before the coating Z, the filter had a backpressure of 68.5 mbar, while the backpressure after the coating with Z was 68.6 mbar.

Both filters were then first loaded with 7 grams of soot on a direct injection gasoline engine and subsequently weighed. Thereafter, the filters were again installed into the exhaust line of the engine and were brought to a temperature of 500 °C with rich exhaust gas under exclusion of oxygen. Subsequently, the exhaust gas composition was changed from rich to lean exhaust gas (lambda 1.1) and the decrease in backpressure was then recorded as a function of time. As can be seen in FIG. 11, the backpressure of the soot-laden filter according to the invention (gray color/example 1) decreases significantly faster than the backpressure of the comparison filter, which does not have a coating Z. This is in particular quite surprising since, contrary to the applicable technical literature, no carrier materials with high specific surfaces such as aluminum oxide, cerium oxide, cerium/zirconium mixed oxide, or other oxides known to the person skilled in the art are required to catalyze the oxidation of the particles. As can also be seen in FIG. 11 in the range of the first 500 seconds of the test, the filter according to the invention including coating Z has the same backpressure as the equivalent filter without coating F. The filtration efficiency of the filter according to the invention in the WLTP cycle at 84.7% is also unchanged in comparison to that of the reference filter.

The combination of coating F and coating Z thus provides an elegant way to catalyze the oxidation of soot particles, especially in the range of 10-23 nm, without degrading the original physical properties of the filter, such as the pressure loss.

1.-18. (canceled)

19. A wall-flow filter for removing particles from the exhaust gas of internal combustion engines, in particular predominantly stoichiometrically operated internal combustion engines, which comprises a wall-flow filter substrate of length L and different coatings Z and F, wherein the wall-flow filter substrate comprises channels E and A, which extend in parallel between a first and a second end of the wall-flow filter substrate, are separated by porous walls and form surfaces OE and OA, respectively, and wherein the channels E are closed at the second end and the channels A are closed at the first end, and wherein the coating F is located in the porous walls and/or on the surfaces OE and/or on the surfaces OA and comprises a filtration-increasing layer and no precious metal, and the coating Z is located in the porous walls and/or on the surfaces OE and/or OA and/or on the end faces of the channels E and/or A and/or on the constituents of the coating F and contains platinum and/or palladium, and wherein coating Z extends over at least a sub-region of 3 mm to 100% of the length L of the filter, wherein the coating F is selected from the group consisting of aluminum oxide, zirconium dioxide, cerium oxide, yttrium oxide, mullite, tin oxide, silicon nitride, zeolite, titanium dioxide, silicon dioxide, aluminum titanate, silicon carbide, cordierites, nesosilicates, phyllosilicates, technical silicates, chain silicates, group silicates, or mixtures thereof, and the components of coating F are fixed on the ceramic wall-flow substrate, wherein the mass of the precious metal of the coating Z is 0.1-20 grams per liter of filter volume and does not have any ceramic or oxidic portions, characterized in that first coating F and then coating Z is applied to the filter substrate.

20. The wall-flow filter according to claim 19, characterized in that the filtration-increasing coating F is located substantially on the surfaces OE.

21. The wall-flow filter according to claim 20, characterized in that the coating F has a layer thickness of 1 to 150 μm.

22. The wall-flow filter according to claim 20, characterized in that the ratio of the wall thickness of the wall-flow filter substrate to the thickness of the coating F is 0.8 to 400.

23. The wall-flow filter according to claim 20, characterized in that the coating Fis located in the porous walls of the wall-flow filter substrate at 1 to 50% of the total mass of the coating F.

24. The wall-flow filter according to claim 19, characterized in that the filtration-increasing coating F does not form a continuous coating on the surfaces O_{E}.

25. The wall-flow filter according to claim 19, characterized in that coating F has an increasing concentration gradient in the longitudinal direction of the filter from its first to its second end.

26. The wall-flow filter according to claim 19, characterized in that coating F advantageously has a mass of 1 to 50 g/L in relation to the volume of the wall-flow filter substrate.

27. The wall-flow filter according to claim 19, characterized in that the mass ratio of platinum to palladium is 0.05-20.

28. A system for cleaning exhaust gases from internal combustion engines, in particular predominantly stoichiometrically operated internal combustion engines, which contains a wall-flow filter analogous to claim 19, which is arranged downstream of a three-way catalyst close to the engine.

29. The system for cleaning exhaust gases according to claim 28, characterized in that, downstream of the wall-flow filter, there is at least one further catalyst selected from the group of three-way catalyst, oxidation catalyst, NOx storage catalyst, hydrocarbon trap, SCR catalyst, ammonia slip catalyst.

30. A method for exhaust gas reduction of an internal combustion engine, in particular a predominantly stoichiometrically operated internal combustion engine, in which the exhaust gases of the engine are conducted over a wall-flow filter according to claim 19.

31. A method for exhaust gas reduction of a predominantly stoichiometrically operated internal combustion engine, in which the exhaust gases of the engine are conducted over a system of claim 28.
